(19) United States
(12) Patent Application Publication
(10) Pub. No.: US 2008/0023381 A1
(43) Pub. Date: Jan. 31, 2008

(54) Fluid Filtration System and Method of Filtering Fluid

(76) Inventors: Nicholas Jackson, Lancashire (GB); Andrew Clark, Buckinghamshire (GB); Colin French, Lancashire (GB)

Correspondence Address: JACKSON WALKER LLP, 901 MAIN STREET, SUITE 6000, DALLAS, TX, 75202-3797, US

(21) Appl. No.: 10/579,350

(22) PCT Filed: Nov. 15, 2004
(86) PCT No.: PCT/GB04/04803

§ 371 Date: Aug. 16, 2007

(30) Foreign Application Priority Data
Nov. 14, 2003 (GB) 0326629.3

(51) Int. Cl. B01D 29/00; B01D 29/15; B01D 29/68

(52) U.S. Cl. 210/106; 210/120; 210/137; 210/323.2; 210/333.01; 210/411; 210/512.1; 264/13

(57) ABSTRACT

The present application relates to a filtration system (1) having at least one flexible filter (9) and cleaning apparatus (25) for projecting a flow of fluid onto the at least one flexible filter. The fluid to be filtered passes through the at least cone flexible filter (9) and causes the at least one flexible filter (9) to be deflected in a first direction. The flow of fluid projected onto the at least one flexible filter (9) from the cleaning apparatus (25) causes the at least one flexible filter (9) to be deflected in a second direction. The first and second directions are substantially opposite to each other. The present invention further relates to a filtration system (1) for filtering particulates from a liquid. The filtration system has a sealed vessel (2) suitable for supporting a pressure less than atmospheric pressure. A filter (9) is provided for filtering particulates from the liquid. The application also relates to a method of filtering fluid.

The present application relates to a filtration system for filtering particulates and other matter from a fluid. The application further relates to a method of filtering particulates and other matter from a fluid.

It is known from PCT/AU96/00295 to provide a cylindrical mesh filter inside a chamber having an inlet port and an outlet port. The water to be filtered is introduced through the inlet port and passes through the filter before exiting through the outlet port. The particulates filtered from the water are trapped on the exterior surface of the mesh. The system is flushed by simultaneously injecting filtered water into the inlet port and opening a drain port while the filter is pressurised. A rotatable member is provided inside the cylindrical filter to spray filtered water onto the interior surface of the cylindrical mesh to dislodge filtered particulates trapped therein.

Filtration systems of the above type typically have a pump located upstream of the filter for supplying the liquid to the filter. However, as the liquid passes through the pump any particulates or other subject matter suspended in the liquid tend to be macerated by the pump. Therefore, the size of the particulates to be filtered is reduced and the size of the mesh required to filter the particles must be reduced accordingly. Moreover, the smaller the particulates suspended in the liquid the longer they take to settle. Thus, the efficiency of the system may be reduced.

A further disadvantage of filtration systems of the above type is that they generally require separate supply and purging pumps which increases the purchase and running costs of the apparatus.

Viewed from a first aspect the present application relates to a filtration system comprising at least one flexible filter for filtering a fluid and cleaning apparatus for projecting a flow of fluid onto the at least one flexible filter; wherein, in use, the fluid to be filtered passes through the at least one flexible filter and causes the at least one flexible filter to be deflected in a first direction, and the flow of fluid projected onto the at least one flexible filter from the cleaning apparatus causes the at least one flexible filter to be deflected in a second direction. The first and second directions may be substantially opposite to each other.

The deflection of the at least one flexible filter in first and second directions when the system is operating helps to dislodge particulate material and may thereby assist in the cleaning thereof. The deflection of the at least one flexible filter may also help to prevent bacteria growing on the mesh.

The cleaning apparatus for projecting a flow of fluid onto the at least one flexible filter may be fixed in position and the at least one flexible filter moveable. Preferably, however, the at least one flexible filter is fixed in position and the cleaning apparatus is moveable.

The at least one flexible filter typically flexes, bows or curves when it is deflected in said first or second direction.

The at least one flexible filter may be generally planar, for example suitable for extending across a pipe or other conduit. Preferably, however, the at least one flexible filter defines a chamber. Most preferably, the system comprises a plurality of flexible filters that collectively form a cylinder. The cleaning apparatus may be provided inside the chamber for projecting fluid onto an interior surface thereof; or the cleaning apparatus may be provided outside of the chamber for projecting fluid onto an exterior surface thereof.

In arrangements where the at least one flexible filter defines a chamber and the fluid passes through the at least one flexible filter to the interior of the chamber to be filtered, the at least one flexible filter is deflected inwardly, into said chamber, when the fluid passes through the flexible filter to be filtered. The at least one flexible filter is deflected outwardly, out of said chamber, by the fluid expelled from the cleaning apparatus. Conversely, in arrangements where the at least one flexible filter defines a chamber and the fluid passes from the interior of the chamber to the exterior thereof to be filtered, the at least one flexible filter is deflected outwardly, out of said chamber, when the fluid passes through the filter to be filtered. The at least one flexible filter is deflected inwardly, into said chamber, by the fluid expelled from the cleaning apparatus.

The cleaning apparatus preferably comprises a member through which the fluid is projected. The member is preferably moveable. The member may be moveable along a linear path but it is preferably rotatable.

The flexible filter(s) is/are typically supported by one or more frame members. The filter may thereby be sufficiently flexible to undergo deflection in use, whilst allowing it readily to be mounted in place. Arrangements where the flexible filter(s) is/are directly attached to a housing member, for example by adhesive or mechanical fastening means, are also envisaged.

The at least one flexible filter may be wire gauze or other lightweight metal material. Preferably, however, the at least one flexible filter is made of a plastics material, such as polyester or nylon. The at least one flexible filter may alternatively be made of foam.

The at least one flexible filter may be provided with an anti-bacterial coating further to assist in maintaining the flexible filter free from bacteria. Alternatively, an anti-bacterial additive, such as Microban (RTM) may be added to the plastics material from which the flexible filter is formed.

Viewed from a further aspect, the present invention relates to a filtration system for filtering particulate material from a fluid, the filtration system comprising at least one flexible filter capable of being deflected by the flow of fluid through it. The at least one flexible filter mesh is deflected, in use, in the same direction as the flow of fluid through the mesh. The flow of fluid typically causes the at least one flexible filter to flex.

Viewed form a still further aspect, the present application relates to a filter for filtering particulates from a flow of fluid, the filter comprising at least one flexible filter mesh capable of being deflected by the flow of fluid through it. The filter mesh is deflected, in use, in the same direction as the flow of fluid through the mesh.

Viewed form a yet further aspect, the present application relates to a filter for filtering particulates from a flow of fluid, the filter being flexible and capable of being deflected by the flow of fluid through it.

The arrangements outlined herein in respect of the filter and filter mesh employed in the filtration system are equally applicable to the filter described herein.

The filter is preferably a cylindrical filter.

Viewed a still further aspect, the present application relates to a filtration system for filtering particulate material from a fluid, the filtration system comprising at least one flexible filter for filtering the fluid, said at least one filter being capable of being deflected in the same direction as the fluid flow.

The filter and filter mesh described herein may be moveable, for example rotatable, relative to cleaning apparatus for projecting a fluid onto the filter or filter mesh. Preferably, however, the filter or filter mesh is fixed and the cleaning apparatus is moveable.

Viewed from a further aspect, the present application relates to a filtration system operable in a filtration mode and a purging mode, the system comprising at least one flexible filter; wherein, in use, said at least one flexible filter is deflected in a first direction when the system is operating in said filtration mode, and is deflected in a second direction when the system is operating in said purging mode. The first and second directions may be substantially opposite to each other.

The filtration system preferably comprises cleaning apparatus for projecting a flow of fluid onto the at least one flexible filter to dislodge material trapped in the at least one flexible filter. The at least one flexible filter is preferably deflected in said second direction by the flow of the fluid from the cleaning apparatus even if the filtration system is operating in its filtration mode.

Viewed from a yet still further aspect, the present application relates to a method of manufacturing a filter for a filtration system, the filter comprising at least one filter mesh and a frame, the method comprising the steps of: (a) locating said at least one filter mesh in a mould; and (b) injecting plastics material into the mould to form said frame and to fix said at least one filter mesh in said frame.

The step of locating the filter mesh in the mould prior to introducing the plastics material allows the filter mesh to be securely fixed in place. This method of manufacturing the filter is considered to be applicable to the production of a range of filtration system filters and not just filters for those systems described herein.

To further improve the manufacturing process, the or each filter mesh is preferably mounted in a support member and said support member and the filter mesh are located in the mould together, prior to the injection of the plastics material. Mounting the filter mesh in a support member allows them more readily to be handled.

The filter mesh is preferably flexible such that, in use, it is capable of being deflected in the same direction as the fluid flow through the filter.

The filter may be substantially planar, for example for mounting in a conduit, but it is preferably a cylindrical filter.

The present application further relates to a filter manufactured by the method described herein.

Viewed from a further aspect the present invention provides a filtration system for filtering particulates from a liquid, the system comprising a sealed vessel suitable for supporting a pressure less than atmospheric pressure, and a first filter for filtering particulates from said liquid. The provision of a sealed vessel advantageously allows liquid to be drawn through the system.

In use, air may come out of suspension in the liquid, for example due to the changes of pressure in the system, and this may collect and form air pockets which prevent the operation of the system. An air evacuation means suitable for evacuating air from the system is preferably provided to ameliorate these problems. The air evacuation means advantageously helps prevent pockets of air forming in the filtration system. For example, the air evacuation means may prevent an air pocket forming in the sealed vessel. The air evacuation means may be an air pump. Preferably, however, the air evacuation means is a venturi. Preferably the venturi is provided on the pressure side of a pump.

Alternatively, the air evacuation means may be a tube or conduit connected to the inlet side of the pump. When the pump is operating, the pressure on the inlet side is reduced and this may draw air into the fluid flow into the pump.

The sealed vessel preferably defines a first chamber inside of which is provided the first filter. The first chamber is preferably maintained at least substantially full of liquid when the filtration system is operating.

A pump is preferably provided for reducing the pressure in the sealed vessel to draw liquid to be filtered into the vessel. The pump preferably draws filtered liquid out of the sealed vessel to cause said reduction in pressure. Preferably, the filtered liquid then passes through the pump and may be pumped to the system outlet. Preferably, in normal operation, the volume of liquid drawn into the sealed vessel to be filtered is substantially the same as the volume of filtered liquid drawn out of the sealed vessel by the pump.

A valve sub-system is preferably provided to allow the system to be changed between a filtration mode and a purging mode. The valve sub-system preferably changes the connection of the pump to the sealed vessel to change between the filtration and purging operational modes.

In the purging mode, the pump is preferably connected upstream of the sealed vessel. The pump preferably introduces a purging liquid into the sealed vessel to flush filtered particulates through a discharge outlet. The purging liquid is preferably introduced into the sealed vessel so as to reverse the direction of flow of the liquid through the first filter (relative to the flow direction when the system is operating in the filtration mode) so as to purge the filter. The valve sub-system is preferably operable to open the discharge outlet when the system is operating in the purging mode. Similarly, the valve sub-system is preferably operable to close the inlet into the sealed vessel when the system is operating in the purging mode.

The purging liquid may be liquid which has been filtered through the first filter provided in the first chamber and then stored in a suitable reservoir. Alternatively, the purging liquid may be taken from a dedicated source, such as a mains water supply. Most preferably, however, the purging liquid is drawn from the supply of liquid to be filtered to avoid the need for a reservoir or a dedicated supply. A second filter may be provided to filter the purging liquid prior to its introduction into the sealed vessel.

In the filtration mode, the pump is preferably connected downstream of the first filter so as to draw liquid through the first filter. This arrangement advantageously allows a single pump to draw liquid from a plurality of sources, such as different conduits placed around a pond or other body of water. The liquid is preferably drawn into the sealed vessel through a system inlet connected to at least one conduit having at least one opening therein. In use, each of opening in the at least one conduit is preferably submerged in the liquid to be filtered to help prevent air being drawn into the filtration system.

The liquid is preferably drawn into the sealed vessel in a tangential direction so as to establish a rotational flow inside the sealed vessel. This rotational flow may advantageously draw particulates towards the centre of the vessel to allow more efficient filtration and/or collection.

The filtration system preferably further comprises a biological filter. The biological filter preferably comprises bio-media. When the system is operating in the filtration mode, at least some of the mechanically filtered liquid from the first chamber is preferably pumped to a second chamber in which the biological filter is provided. Preferably the second chamber is annular in cross-sectional shape and extends circumferentially around the first chamber. Of course, the second chamber may be separate from the first chamber and connected thereto by one or more conduits.

In known filtration systems, bio-media is agitated by injecting a gas into the liquid in which the media is provided. However, the inventors in the present case have recognised that the liquid to be biologically filtered may be introduced in such a way as to agitate the bio-media and thereby reduce or remove the need to introduce gas for this purpose. The recognition of this possibility is considered to be independently patentable. Preferably, the liquid to be biologically filtered is introduced into the second chamber so as to induce a rotational flow of the liquid in that chamber and thereby to agitate the bio-media.

A third mechanical filter may be provided downstream of the first filter to perform an additional filtration step to remove particulates which have passed through the first filter. The third filter may, for example, be a foam member through which the liquid passes.

A UV light module may be provided to perform a final cleaning operation on the liquid before it is expelled from the filtration system.

The filtration system preferably also comprises a filter cleaning apparatus operable during the filtration mode. In the filtration mode, the cleaning apparatus preferably projects a cleaning liquid onto a downstream side of the first filter to dislodge particulates trapped on an upstream side thereof. The cleaning liquid is preferably liquid taken from downstream of the first filter, i.e. liquid which has already been mechanically filtered at least once. Although a separate dedicated pump may be provided to pump the cleaning liquid into the cleaning apparatus, the cleaning liquid is preferably pumped to the cleaning apparatus by the pump which draws liquid though the first filter. Of course, the cleaning liquid may be supplied from any other suitable source, for example a mains water supply.

The cleaning apparatus may be fixed and the filter arranged to move relative thereto, but preferably the filter is fixed and the cleaning apparatus is moveable. The cleaning apparatus preferably comprises a rotatable member having at least one outlet for projecting said cleaning liquid onto the downstream surface of the filter. The rotatable member is preferably rotatably mounted on a tubular member having at least one side-opening in liquid communication with an interior of the rotatable member.

The tubular member preferably has a closure member provided for directing liquid introduced into the tubular member through the at least one side-opening. The closure member is preferably generally frusto-conical in shape so as to efficiently direct the liquid in a radially outward direction. The closure member more preferably is frusto-conical in shape having a concave outer surface. The closure member may be fixedly attached to, or integrally formed with, the tubular member.

The supply of cleaning liquid to the cleaning apparatus is preferably controlled by the valve sub-system. In certain preferred embodiments, cleaning liquid is only supplied to the cleaning apparatus when the system is operating in the filtration mode.

A flow compensating device is preferably provided to increase the proportion of the cleaning liquid directed to the filter cleaning apparatus if the filter becomes partially blocked. The flow compensating device is preferably a spring-loaded valve and is preferably located downstream of an inlet into the cleaning apparatus. The spring-loaded valve is preferably maintained in a fully open position when the flow rate of filtered liquid is sufficient to overcome the force of the spring. When the flow rate of the filtered liquid falls, for example because the filter is partially blocked, the spring preferably biases the valve towards its closed position thereby reducing the proportion of filtered liquid which may pass the flow compensating device and increasing the proportion directed to the inlet for the cleaning apparatus. The spring-loaded valve may be disc-shaped. Preferably, however, the valve has a conical portion which cooperates with a conical portion defined in an inside wall of a conduit in which the valve is located.

In the purging mode, the purging liquid is preferably introduced into the sealed vessel through the cleaning apparatus. Thus, liquid preferably passes through the first filter in opposite directions in the purging and filtration modes. The purging liquid dislodges particulates from the filter and these are displaced through the sealed vessel's discharge outlet, together with the purging liquid, and expelled from the filtration system.

If a flow compensating device is provided, this may be closed during the purging mode. Preferably, the valve sub-system closes the flow compensating device during the purging mode.

The first filter is preferably a cylindrical mesh and defines a third chamber in the filtration system. The cleaning apparatus is preferably located inside said mesh and is rotatable about the central axis of the cylinder. The mesh is most preferably in the form of a right cylinder.

The filter is preferably provided in an upper portion of the first chamber to facilitate, in use, the settling of particulates filtered from the liquid supply in a lower portion of the first chamber. At least one baffle plate is preferably provided between the upper and lower portions of the first chamber to reduce the movement of the liquid in the lower portion of the first chamber. The baffle plate is preferably hollow frusto-conical in shape. The pump and the discharge outlet are preferably located in the lower portion of the first chamber.

A settling chamber may be provided in the first chamber to collect particulates suspended in the water. These particulates are generally small in size and sink only slowly to the bottom of the first chamber and tend to be drawn towards the centre of the first chamber by the rotation of the water therein. The collection device is preferably provided in the lower portion of the first chamber beneath the filter and also the at least one baffle plate (if fitted). The settling chamber is preferably defined by a cylindrical member which is open at its upper end. The settling chamber is preferably provided with an outlet though which particulates may be discharged. The outlet may be controlled by the valve sub-system. The settling chamber is preferably arranged co-axially with the tubular member which supports the rotatable member. The settling chamber is preferably purged when the system operates in its purging mode.

The system preferably comprises a pressure relief valve operable to prevent the pressure in the sealed vessel falling below a predetermined level. The pressure relief valve is preferably operable to place an inlet and an outlet of the pump in communication with each other to prevent further reduction in the pressure in the sealed vessel whilst allowing the pump to continue to operate. A spring valve provided in the pressure relief valve preferably determines the pressure at which the relief valve operates.

The valve sub-system may be operated automatically, for example in response to a timer or a pressure switch, to change the operational mode of the filtration system. Preferably, however, the valve sub-system is manually operated.

Liquid is preferably pumped through the pump in the same direction when the system is operating in the filtration and purging modes.

The liquid to be filtered preferably enters the first chamber in a tangential direction to create a rotational flow in the region of the filter. A rotational flow tends to establish a flow pattern which improves the efficiency of the system.

Viewed from a further aspect, the present application relates to a filtration system for filtering particulates from a fluid, the filtration system comprising a filter and a chamber for collecting particulates; the system further comprising at least one baffle member for reducing the velocity of fluid in the chamber and/or the velocity of fluid entering said chamber.

The reduction in the velocity of the fluid in the chamber reduces the ability of the fluid to suspend particulate material. Thus, the particulate material is more rapidly deposited at the base of the chamber.

The baffle member(s) may be ring-shaped, frusto-conical or hollow frusto-conical. The at least one baffle member preferably has a downwardly sloping top surface to help prevent the build-up of particulate material on top of the baffle member.

The filtration system preferably comprises first and second baffle members, wherein the first baffle member has a first top surface and the second baffle member has a second top surface. The first top surface preferably slopes downwardly in a first direction and the second top surface preferably slopes downwardly in a second direction, said first and second directions being substantially opposite to each other. This arrangement has been found to be particularly effective in reducing the velocity of the fluid within the chamber. In arrangements where the first and second baffle members are ring-shaped, frusto-conical or hollow frusto-conical, the first direction may be radially inward and the second direction radially outward. The first baffle member may be located in substantially the same plane, for example in a concentric arrangement, but preferably the first baffle member is located either above or below the second baffle member.

Viewed form a still further aspect, the present application relates to a container for collecting particulates in a fluid filtration system, the container having a chamber and being provided with at least one baffle member for reducing the velocity of fluid in the chamber and/or the velocity of fluid entering said chamber.

Again, the baffle member(s) may be ring-shaped, frusto-conical, or hollow frusto-conical in shape. The top surface of each baffle member preferably slopes downwardly to prevent particulate material collecting on them.

The baffle members are preferably baffle plates.

Viewed from a further aspect, the present application relates to a method of operating a filtration system to filter particulates from a liquid, the method including a filtration step and a purging step; the filtration step comprising reducing the pressure in a sealed vessel below atmospheric pressure to cause liquid to be filtered to be drawn into the sealed vessel, and passing the liquid through a filter; the purging step comprising introducing a purging liquid into the sealed vessel to expel particulates filtered from the liquid supply through a discharge outlet.

The method preferably comprises reducing the pressure in the sealed vessel by operating a pump to draw liquid out of the sealed vessel. The liquid is preferably drawn through the system and passes through the filter causing particulates to be mechanically filtered. The purging liquid may be taken from any suitable supply, such as a mains water supply or a reservoir of filtered liquid. Preferably, however, the purging liquid is taken from the supply of liquid to be filtered.

Preferably, the same pumps draws liquid through the system in the filtration mode as displaces the purging liquid through the system in the purging mode. A changeover valve is preferably provided to change between said filtration and purging operational modes.

Viewed from a further aspect the present application relates to a filter cleaning apparatus comprising a rotatably mounted member having at least one outlet for projecting cleaning liquid onto a surface of a filter, the rotatable member having a channel connecting at least one inlet aperture to said at least one outlet, the rotatable member being mounted on a tubular member having at least one side-opening therein, the at least one side-opening being in liquid communication with said at least one inlet provided in the rotatable member.

Providing at least one side-opening in the tubular member advantageously results in the liquid supplied to the rotatable member travelling in a radial direction. The resulting axial forces on the rotatable member, and consequently the loads between the rotatable member and the tubular member, may be significantly reduced. Frictional forces acting on the rotational member may also be reduced. The balancing of the rotatable member is particularly advantageous and filter cleaning apparatus of this type may be employed in a range of applications, including: liquid and gas filtration systems; pressurised, un-pressurised and suction filtration systems.

The rotatable member is preferably symmetrical about a plane perpendicular to the axis about which it rotates. The rotatable member then has substantially equal upper and lower internal surface areas and the force exerted by the cleaning liquid along the axis about which the rotatable member rotates is minimised.

Preferably, fluid is allowed also to escape at the junction between the rotatable member and the tubular member on which it is mounted. This additional flow of fluid advantageously maintains the bearing surfaces substantially free of particulates. Indeed, the flow of liquid around the base of the rotatable member may support the rotatable member and further reduce frictional forces and also reduce wear on the components as they rotate. A gap of, for example, 1 mm or less may be provided between the rotatable member and the tubular member.

The rotatable member preferably has a central collar portion extending around the tubular member. The at least one inlet aperture is preferably provided on the inside of said collar. The at least one inlet aperture preferably extends substantially around the circumference of the tubular member. More preferably the collar is at least partially open to the interior thereof to define said at least one inlet aperture. This arrangement advantageously ensures that liquid communication between said at least one outlet and said at least one inlet aperture is maintained irrespective of the angular orientation of the rotatable member.

First and second annular projections are preferably provided on the outer surface of the tubular member to locate axially the rotatable member. A closure member is preferably provided to direct liquid introduced into the tubular member radially outwardly into the at least one inlet aperture in the rotatable member. The closure member is preferably frusto-conical in shape.

The features of the cleaning apparatus may readily be utilised as part of the filtration system described elsewhere in the present application.

Viewed from a yet still further aspect, the present application relates to a filter cleaning apparatus comprising a rotatable member for projecting a fluid onto a surface of a filter, the rotatable member comprising a collar rotatably mounted on a support member and there being provided at least one fluid pathway for allowing fluid to escape between the support member and the collar.

The provision of a fluid pathway between the support member and the collar allows fluid to escape and helps to maintain clean the bearing formed by the collar and the support member. The fluid escaping between the bearing surfaces also helps to lubricate the bearing.

The fluid to be projected onto the surface of the filter is typically supplied to the rotating member through an inlet formed in the collar and expelled through an outlet provided at an end distal to the collar. The fluid pathway is separate from both the inlet and outlet.

The fluid to be supplied to the inlet is preferably supplied through the support member. Most preferably, the support member is a tubular member. Although the collar may extend only partially around the support member, it preferably extends completely around the support member.

A first guide member is preferably provided on the support member to limit upwards displacement of the rotatable member relative to the support member. The fluid pathway or one of said fluid pathways may at least partially be formed by a gap provided between the collar and said first guide member.

A second guide member is preferably provided on the support member to limit downwards displacement of the rotatable member relative to the tubular member. The fluid pathway or one of said fluid pathways may be formed at least partially by a gap provided between the collar and said second guide member.

The gap between the collar and the first and/or second guide member(s) is preferably equal to or less than 1 mm. In alternative embodiments, the gap may be less than or equal to 0.5 mm; between 0.5 mm and 1 mm inclusive; or between 1 mm and 1.5 mm inclusive. In exceptional cases, the gap may be greater than 1.5 mm.

The gap between the collar and the first and/or second guide member(s) is preferably uniform along its length to allow a uniform fluid flow between the collar and the support member in use.

The first and/or second guide member(s) are preferably annular and extend around the circumference of the support member. The first and/or second guide member(s) may be projections provided on the support member.

The at least one fluid pathway is preferably annular and extends around the support member. A groove may be provided on the bearing surfaces of the rotatable member and the first and second guide members to help get rid of debris that may get trapped between the respective bearing surfaces.

Viewed from a still further aspect, the present application relates to a filtration system comprising a chamber housing a biological filter media, wherein liquid to be biologically filtered is introduced into the chamber through an inlet, and said inlet is arranged such that, in use, the liquid agitates the filter media. The chamber housing the biological filter is preferably annular in cross-section and more preferably extends circumferentially around a central chamber housing a mechanical filter.

Viewed from a yet still further aspect, the present application relates to a filtration system for filtering liquid from a body of liquid, the system comprising a filter and a pump, the filter being provided on the suction side of the pump when the system is operating in a filtration mode; wherein the system is adapted to allow liquid from the body of liquid to be filtered when the system is located above the level of the liquid in said body of liquid. Advantageously, therefore, the system need not be located below the level of the body of liquid (as is the case in the prior art systems) and may draw liquid through the filter before it passes through the pump. The particulate matter in the water may, therefore, be filtered before the liquid passes through the pump. The filtration system is preferably self priming to help facilitate the desired functionality. The system may be provided with a venturi.

Viewed from a still further aspect the present invention provides a filtration system for filtering particulates from a liquid supply, the system being operable in a filtration mode and a purging mode, the system comprising a first chamber, a filter, a pump and a valve sub-system, the filter being provided in said first chamber; wherein, when the system is operating in the filtration mode, the pump is connected downstream of the first chamber and draws liquid through the filter; and, when the system is operating in the purging mode, the pump is connected upstream of the first chamber and pumps a purging liquid into the first chamber to flush filtered particulates through a discharge outlet; the valve sub-system being operable to change the connection of the pump to the first chamber and thereby to change the operational mode of the system.

The present invention further relates to a method of operating a filtration system to filter particulates from a liquid supply, the method comprising a filtration step and a purging step; the filtration step comprising passing the liquid supply through a filter provided in a first chamber and pumping the filtered liquid through an outlet; the purging step comprising pumping a purging liquid into the first chamber to expel particulates filtered from the liquid supply through a discharge outlet; wherein the pumping of the filtered liquid and of the purging liquid is performed by the same pump and a changeover valve is operated to change the pump connections to the first chamber.

Viewed from a yet still further aspect, the present invention relates to a vessel for use in a filtration system, the vessel comprising a collection chamber for collecting particulates filtered from a fluid, wherein a settling chamber is provided in said collection chamber. The fluid to be filtered is preferably introduced into the collection chamber in a tangential direction to establish a rotational flow in the collection chamber. Advantageously, the rotational movement draws small particulates suspended in the fluid towards the centre of the collection chamber. The settling chamber is preferably provided in the centre of the collection chamber so that particulates may be drawn into it by the rotational flow of the fluid in the collection chamber. A rotational flow of the fluid to be filtered may also cause larger particulates in the fluid to be displaced to the outside of the collection chamber. In use, the movement of fluid in the settling chamber is reduced and suspended particulates are caused to settle more quickly.

A filter is preferably provided in said collection chamber. The settling chamber is preferably provided below said filter.

A first discharge outlet is preferably provided to facilitate expulsion of the filtered particulates from the collection chamber. A second discharge outlet is preferably provided to facilitate expulsion of the filtered particulates from the settling chamber.

The settling chamber is preferably defined by a cylindrical sidewall and is preferably open at its upper end. A baffle plate is preferably provided in the collection chamber. The baffle plate is preferably hollow frusto-conical in shape.

The present application further relates to a filtration system comprising a vessel as described herein.

Preferred embodiments of the present invention will now be described, by way of example only, and with reference to the accompanying drawings, in which:

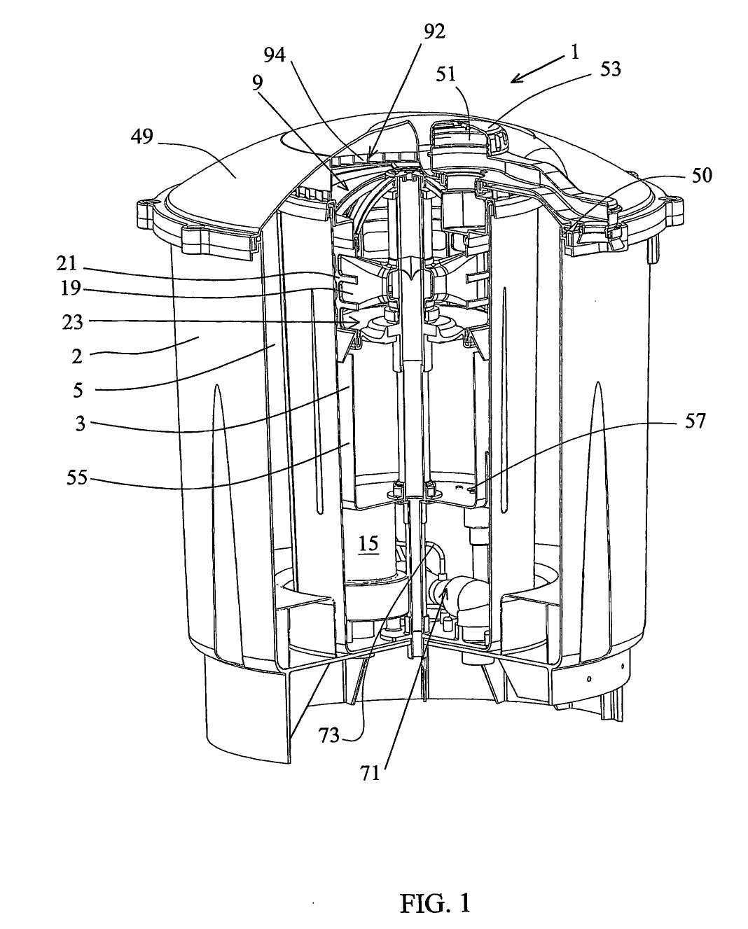

FIG. 1 shows a partial cross-sectional view of a liquid filtration system in accordance with the present invention;

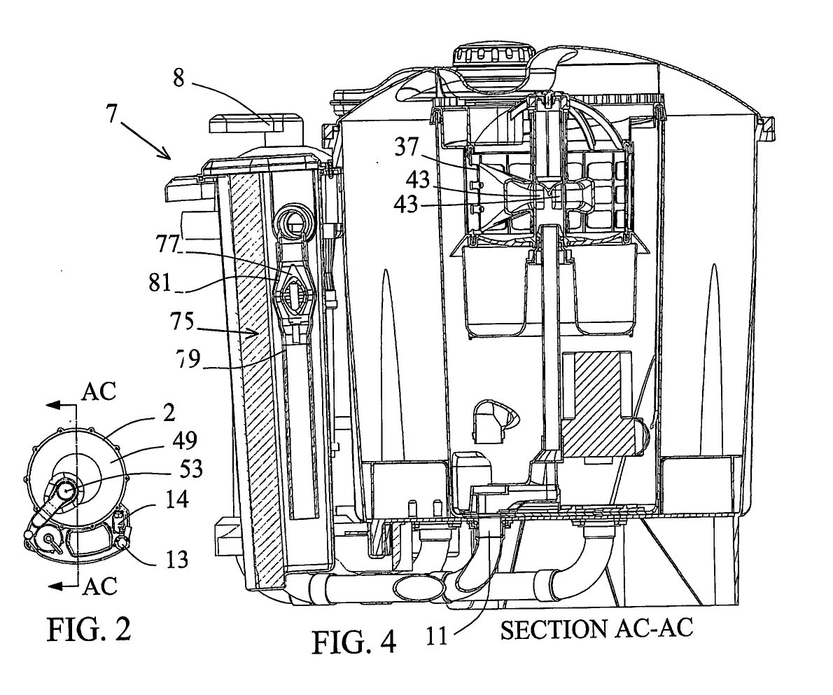

FIG. 2 shows a plan view of the filtration system;

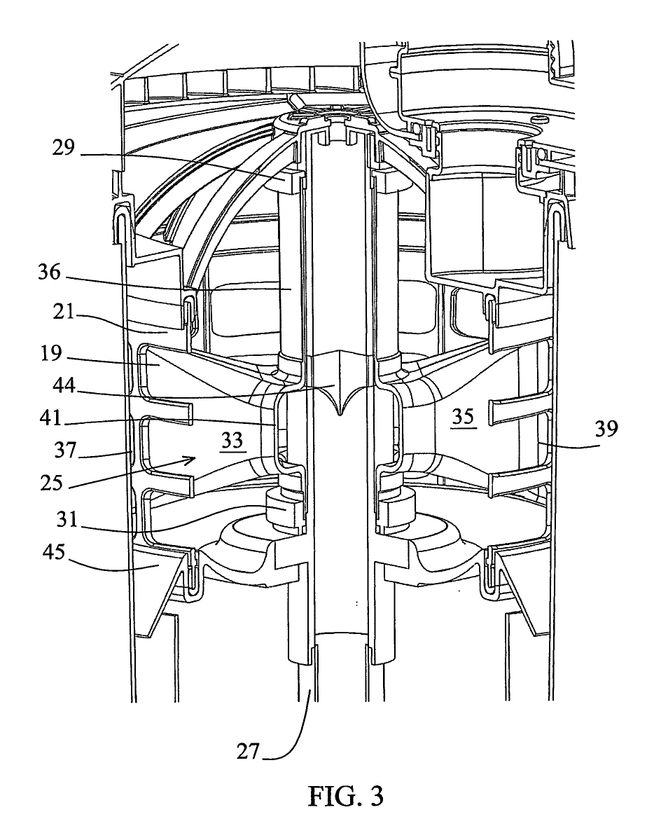

FIG. 3 shows an enlarged view of the rotatable cleaning member of the filtration system shown in FIG. 1;

FIG. 4 shows a cross-section along line AC-AC of the filtration system shown in FIG. 2;

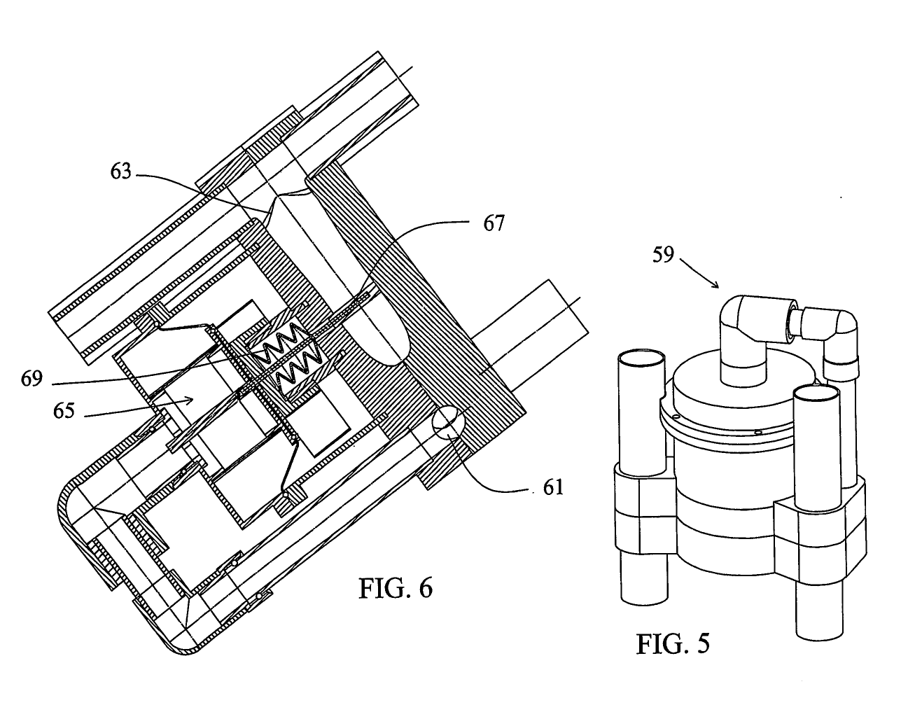

FIG. 5 shows a perspective view of a pressure relief valve for use in the filtration system of the present invention;

FIG. 6 shows a cross-section through the pressure relief valve shown in FIG. 5;

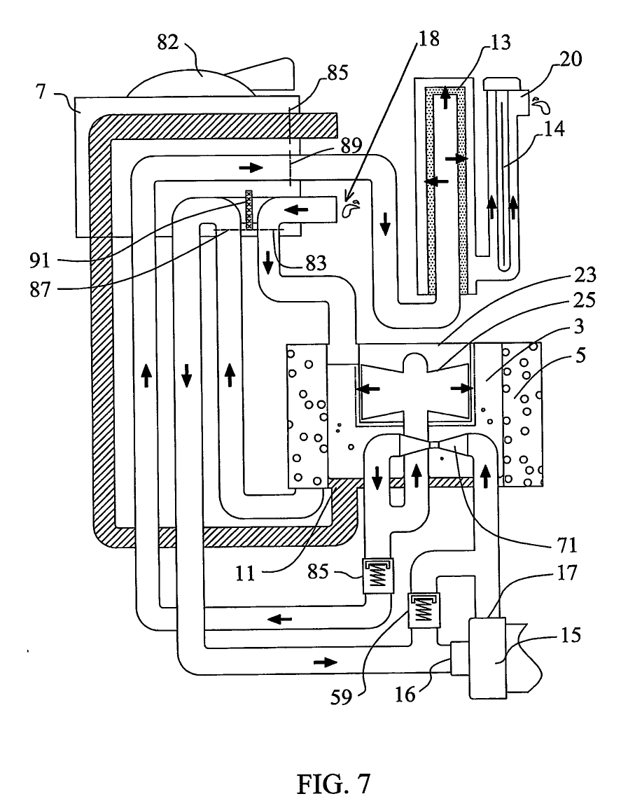

FIG. 7 shows schematically the filtration system operating in a filtration mode;

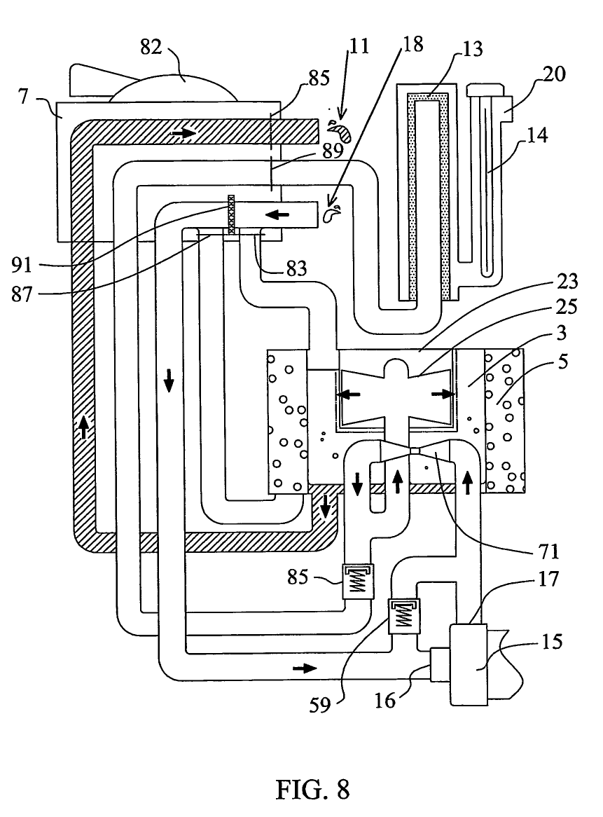

FIG. 8 shows schematically the filtration system operating in a purging mode;

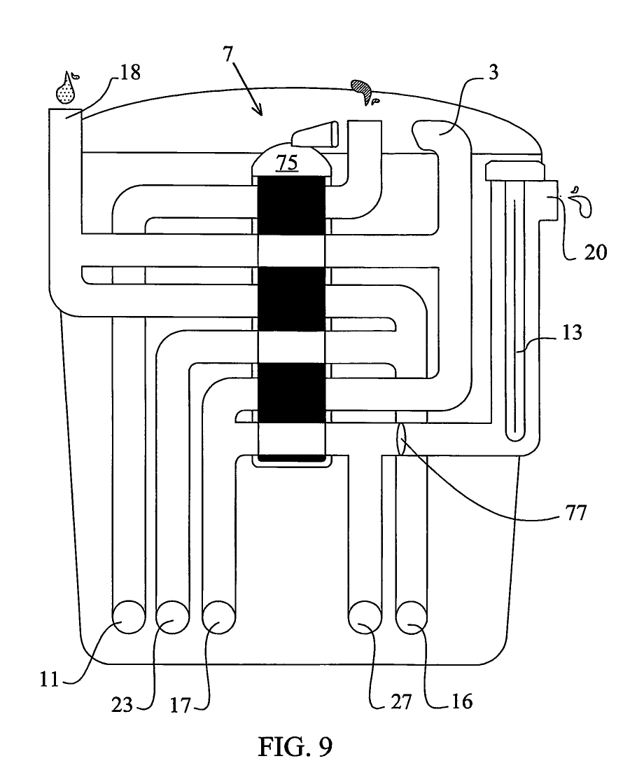

FIG. 9 shows schematically a second embodiment of the filtration system operating in a filtration mode; and

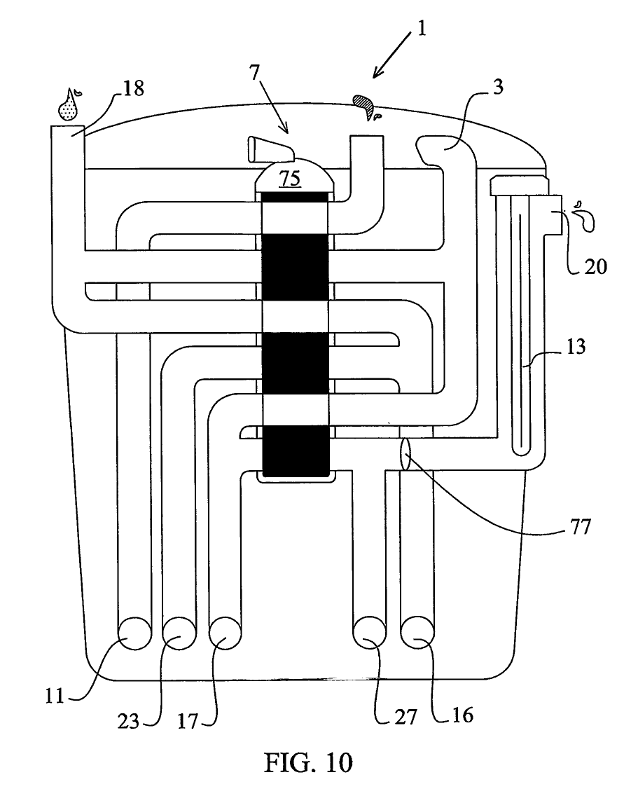

FIG. 10 shows schematically the embodiment of the filtration system shown in FIG. 9 operating in a purging mode.

A liquid filtration system 1 for filtering water from a body of water, such as a pond, in accordance with the present invention is shown in FIG. 1. The filtration system 1 comprises a housing 2, a central chamber 3 and an outer annular chamber 5. The housing 2 is sealed so as to allow a pressure less than atmospheric pressure to be sustained in the central chamber 3 and the outer chamber 5. The filtration system 1 is operable in a filtration mode and a purging mode and a change-over valve system 7 is provided to change between these modes. A plan view of the filtration system 1 is shown in FIG. 2.

The central chamber 3 is circular in cross-section and houses a mechanical filter assembly 9. A discharge outlet 11 is provided in the base of the central chamber 3. The annular chamber 5 is provided around the circumference of the central chamber 3 and houses a biological filter 12, such as the bio-mass supplied by Kaldnes Miljøteknologi AS, Norway. A foam filter 13 is provided to perform an additional filtration step before the filtered water passes through an ultra-violet light module 14.

A circulating pump 15 is provided having an inlet 16 and an outlet 17. The pump 15 draws water into the system 1 through a system inlet port 18. The water may be drawn through a conduit (not shown) connected to the system inlet 18 and having a plurality of inlet apertures open to the body of water to be filtered. Providing a plurality of inlet apertures advantageously allows water to be drawn from different locations which may, for example, be distributed around the body of water. The filtered water is expelled from the filtration system 1 through a system outlet port 20 back into the body of water.

The mechanical filter 9 comprises a cylindrical mesh 19 supported by frame members 21. The mesh defines a filter chamber 23 inside the central chamber 3. Filtered water exits the filter chamber 23 through a filter outlet (not shown). The mesh 19 for the filter 9 may be made frorn any suitable metal or plastics material. Although the flexing of a plastic mesh helps to prevent bacteria growing on the mesh, Microban (RTM) may be added to the plastics material from which the mesh is made, or applied to the surface of the mesh, to limit microbial action.

As most clearly shown in FIG. 3, a rotatable member 25 is provided inside the filter chamber 23 for cleaning the mesh 19. The rotatable member 25 is mounted on a tubular pillar 27 provided in the central chamber 3. The pillar 27 extends downwardly through the base of the central chamber 3 and is connected to the change-over valve system 7, as shown in FIG. 4. A pair of annular projections 29, 31 is provided on the outside of the pillar 15 to locate axially the rotatable member 25.

The rotatable member 25 comprises first and second radially extending fan-shaped members 33, 35 and a shaft portion 36. The radially outermost edges of the fan-shaped members 33, 35 each extend substantially parallel to the inside surface of the cylindrical mesh 19 and each have an outlet 37, 39 defined therein. The outlets 37, 39 are substantially the same axial length as the filter mesh 19 and are inclined at an angle of approximately 20° to a radial direction extending through the axis of rotation of the member 25. The shaft portion 36 helps locate the rotatable member 25 and ensure axial rotation about the pillar 27.

The rotatable member 25 has a central collar 41 extending circumferentially around the pillar 27. The interior of the collar 41 is open to the outside of the pillar 27 about its circumference. A channel is formed in each of the fan-shaped members 33, 35 connecting the open interior of the collar 41 to the outlets 37, 39. The collar 41 is arranged such that the channels in the fan-shaped members 33, 35 extend around the circumference of the pillar 27.

A plurality of side-openings 43 are provided in the pillar 27 between the annular projections 29, 31 which locate the rotatable member 25. As the collar 41 is open to its interior and extends around the circumference of the pillar 27, the channels in the fan-shaped members 33, 35 remain in fluid communication with the interior of the pillar (via the side-openings 43) irrespective of the angular orientation of the rotatable member 25. A closure member 44 having a frusto-conical shape is provided in the pillar 27 to close the upper end thereof and also to direct liquid radially outwardly through the side-openings 43.

A portion of the filtered water introduced into the pillar 27 is allowed to escape between the shaft portion 36 and the annular projections 29, 31 in order to clean the bearings on which the rotatable member 25 rotates. In practice, the rotatable member 25 may be supported by the water as it escapes under pressure and, in use, the rotatable member may effectively “float”. This arrangement helps to ensure that the rotatable member 25 is balanced. The intentional release of water to clean the bearing is facilitated by providing a gap of 1 mm between the shaft portion 36 and each of the annular projections 29, 31. A first hollow frusto-conical baffle plate 45 is provided around the outer, lower edge of the filter 19. A second hollow frusto-conical baffle plate may also be provided inwardly of the first baffle plate 45 around the central pillar 27. The baffle plate 45 divides the central chamber 3 into upper and lower portions.

The mechanical filter 9 is provided in the upper portion of the central chamber 3 and the pump 15 is provided in the lower portion thereof. To facilitate servicing of the pump 15, the housing 2 has a removable cover 49 and the mechanical filter 9 is removable as a unit. An O-ring 50 is provided to create a seal between the housing 2 and the cover 49.

A system priming inlet 51 is provided in the housing 2 to facilitate the introduction of water into the central chamber 3 to prime the pump 15 ready for use. A screw cap 53 is provided sealingly to close the priming inlet 49 during normal operation of the filtration system 1.

A settling chamber 55 is provided in the central chamber 3 beneath the mechanical filter 9. The settling chamber has a cylindrical sidewall and is closed at its lower end. The settling chamber 55 is open at its upper end and this opening is partially shielded by the baffle plate 45 further to reduce the velocity of the water entering the settling chamber. Thus, small particulates suspended in the water in the settling chamber 55 settle relatively quickly. A second discharge outlet 57 is provided at the bottom of the settling chamber to allow the filtered particulates collected therein to be expelled when the filtration system 1 is purged.

As shown in FIGS. 5 and 6, a pressure relief valve 59 is provided to prevent the pressure in the housing 1 falling below a predetermined safety level, for example, if the system inlet port 18 becomes blocked. The pressure relief valve 59 has a first inlet 61 in fluid communication with the pump inlet 16 and a second inlet 63 in fluid communication with the pump outlet 17. A diaphragm 65 is provided in the pressure relief valve 59. If the suction head across the pump 15 exceeds the predetermined level, the diaphragm 65 is displaced and a gate valve 67 is opened to bring the pump inlet 16 and the pump outlet 17 into fluid communication with each other. Thus, further reduction of the pressure in the housing 1 is prevented whilst the pump 15 is allowed to continue to operate. The output flow from the pump 15 is reduced when the gate valve 67 is open but it is generally still sufficient to provide cleaning water to the rotatable member 25 to clear the mechanical filter 9 and allow the filtration system 1 to return to normal operation. A spring 69 biases the diaphragm 65 and the gate valve 67 to their closed positions.

In use, air comes out of suspension in the water as it passes through the filtration system 1 or it may enter through leaks at joints between components. If air is allowed to collect it is necessary periodically to top-up the water levels in the filtration system 1. To help reduce the amount of air which collects, a venturi 71 is provided on the outlet side of the pump 15 and a suction tube 73 is connected to a throat section thereof. The venturi 71 provides a suction force which draws air through the suction tube 73 and into the stream of liquid on the outlet side of the pump 15. The air is then expelled from the filtration system 1 with the filtered water. The suction tube 73 is preferably connected at one end to the venturi 71 on the outlet side of the pump 15 and at the other end to the top of the central chamber 3 to ensure that a pocket of air does not form which may prevent the system 1 from operating.

As shown in FIG. 4, a flow compensating device 75 is provided in a conduit 79 between the inlet for the rotatable member 25 and the foam filter 13. The flow compensating device 75 comprises a spring-loaded conical valve member 77 (shown in its open position) which cooperates with a conical portion 81 of the conduit 79 to close the flow compensating device. A spring (not shown) biases the conical valve member 77 towards its closed position but in normal operation the flow of filtered water through the conduit 79 displaces the valve member towards its open position. A reduction in the flow of liquid through the system 1 (for example as a result of the mesh 19 becoming blocked) allows the spring to bias the conical valve member 77 towards a closed position and, thereby, to reduce the proportion of the flow directed to the foam filter 13 (and system outlet 20) and increase the proportion being directed to the rotatable member 25. The flow compensating device may advantageously operate in conjunction with the pressure relief valve 59 to direct flow to the rotatable member 25 when the gate valve 69 is open and the output from the pump 15 is reduced.

As outlined above, the filtration system 1 may operate in a filtration mode or a purging mode. The mode of operation is determined by the change-over valve system 7 and is selected by manually rotating a handle 81. The change-over valve system 7 comprises an inlet valve 83 for controlling the supply of fluid into the central chamber 3; a debris discharge valve 85 for controlling the discharge of filtered particulates from the system 1; a first filtrate control valve 87 for controlling the flow of filtrate from the annular chamber 5 to the pump 15; and a second filtrate control valve 89 for controlling the flow of filtrate from the pump 15 to the foam filter and the UV module.

The change-over valve system 7 also comprises an inlet filter 91. The inlet filter 91 is by-passed when the inlet valve 83 and the first filtrate control valve 87 are open. Conversely, when the inlet valve 83 and the first filtrate control valve 87 are shut, the inlet flow is directed through the inlet filter.

The operation of the filtration system 1 in the filtration and purging modes will now be described with reference to FIGS. 7 and 8. The valves 83, 85, 87, 89 in the change-over valve system 7 are represented schematically in FIGS. 7 and 8 with a dashed line when they are in their open positions, and with a solid line when they are in their shut positions. The direction of the liquid flow through the system 1 is represented by arrows.

When the filtration system 1 is operating in its filtration mode, the inlet valve 83, and the first and second filtrate control valves 87, 89 are open. The debris discharge valve 85 is shut. The pump 15 draws water from the annular chamber 5 and this in turn draws water from the filter chamber 23 into the annular chamber via a conduit (not shown). The pressure in the filter chamber 23 is thereby reduced and water is drawn into the central chamber 3 through the system inlet 18; the inlet filter 91 is by-passed. The system inlet 18 is arranged such that the water is drawn into the central chamber 3 in a tangential direction so as to establish a rotational flow in the central chamber.

The water enters the central chamber 3 and is drawn through the mesh 19. Particulates suspended in the water drawn into the filter chamber 23 are trapped on the outside surface of the mesh 19 and the water entering the filter chamber is mechanically filtered.

The mechanically filtered water is drawn into the annular chamber 5 where it is biologically filtered. The water exits the filter chamber 23 through an annular opening 92 provided between the lid 49 and the cylindrical housing which defines the central chamber 3. Preferably, the mechanically filtered liquid is introduced into the annular chamber 5 tangentially to induce a rotational motion to agitate the bio-media in the biological filter. A series of vanes 94 are provided in the annular opening 92 to induce the desired rotational motion in the liquid as it enters the annular chamber 5.

The biologically filtered water then enters the pump inlet 16, via the valve change-over system 7, and is pumped through the venturi 71. The pressure is reduced in the throat of the venturi 71 and air is drawn through the suction tube 73 into the water stream.

A proportion of the water downstream of the pump 15 is then directed into the pillar 27. The liquid exits the pillar 27 through the at least one outlet aperture 43 and enters the channels provided in the fan-shaped members 33, 35. The liquid is then expelled through the outlets 37, 39 and impinges on the inner surface of the mesh 19 to dislodge particulates or other matter trapped in the outer surface thereof. The angular inclination of the outlets 37, 39 causes the member 25 to rotate so that the outlets traverse substantially all of the inside surface of the mesh 19.

The particulates dislodged from the outer surface of the mesh 19 sink to the bottom of the central chamber 3. The hollow frusto-conical baffle plate 45 reduces the velocity of the liquid in the lower portion of the central chamber 3 and this reduces the liquid's ability to transport particulates. Thus, the particulates settle on the base of the chamber central 3 relatively quickly.

The proportion of the water introduced into the rotatable member 25 is determined by the flow compensating device 75. If the flow from the pump 15 is reduced because the mesh 19 is partially blocked, the conical valve member 77 will be biased towards its closed position and the proportion of the flow directed to the rotatable member 25 increased to help clean the mesh 19.

The continued action of the pump 15 pumps the liquid to the foam filter 13 and then through the UV light module 14. The filtered water is returned to the body of water via the system outlet 20. An outlet conduit (not shown) is connected to the system outlet 20 to deliver the filtered water to the desired location. The outlet conduit may have a plurality of openings to discharge the filtered water in different locations.

When the filtration system 1 is operating in the purging mode, the inlet valve 83, and the first and second filtrate valves 87, 89 are shut. The debris discharge valve 85 is open. The liquid supply for the system 1 is fed to the pump inlet 16 via the inlet filter 91. The pump 15 pumps the liquid into the central chamber 3 via the rotatable member 25. The purging liquid washes the mesh 19 and displaces any particulates trapped therein into the central chamber 3. The purging liquid and the filtered particulates are then discharged from the central chamber 3 through the first discharge outlet 11. The purging liquid also discharges particulates collected in the settling chamber 55 through the second discharge outlet 57. The debris is expelled from the system 1 through the open debris discharge valve 85.

The purging operation is preferably performed periodically for 10 to 15 seconds. During the purging mode, the pressure in the central chamber 3 may be greater than atmospheric pressure to assist in the expulsion of the accumulated particulates.

The inlet filter 91 is readily accessible to facilitate manual cleaning as required.

The arrangement of the present invention whereby the pump 15 draws the liquid to be filtered through the mesh 19 in the filtration mode is particularly advantageous as it prevents the particulates suspended in the liquid from being macerated by the pump prior to filtration. In known systems, where the liquid to be filtered passes through the pump before reaching a mechanical filter, the particulates are typically much smaller as a result of the action of the pump and, therefore, a finer filter mesh is required. Moreover, the drawing action of the pump advantageously allows liquid to be drawn into the filtration system 1 from a plurality of locations, for example, using a Y-shaped inlet tube.

A second embodiment of the present invention is shown schematically in FIGS. 9 and 10. The second embodiment is similar to the first embodiment described above and like reference numerals have been used for like components. The second embodiment is not, however, provided with a foam filter 13.

The operation of the filtration system 1 according to the second embodiment will now be described with reference to FIGS. 9 and 10 in which the change-over valve system 7 is shown schematically with the blacked-out regions illustrating a closed valve.

When the filtration system 1 according to the second embodiment is operating in a filtration mode, water is drawn into the system 1 through the system inlet 18 by the pump 15, as shown in FIG. 9. The water enters the central chamber 3 and is drawn through the mesh 19 into the filter chamber 23 by the pump 15. Particulates suspended in the water drawn into the filter chamber are trapped on the outside surface of the mesh 19 and the water entering the filter chamber 23 is thereby mechanically filtered.

The pump 15 then draws the mechanically filtered water through the filter outlet and into the pump inlet 16 via the valve change-over system 7. The water is then pumped out of the pump outlet 17 and into the annular chamber 5 for biological filtration. Preferably, the mechanically filtered liquid is introduced into the annular chamber 5 tangentially to induce a rotational motion in the water in the annular chamber. The rotational motion of the water agitates the bio-media in the biological filter and may remove the need to inject gas into the biological filter to perform this function. The continued action of the pump 15 forces the biologically filtered liquid in the annular chamber 9 into the UV light module 14.

A proportion of the mechanically filtered water downstream of the pump 15 is pumped into the pillar 27. The liquid exits the pillar 27 through the at least one outlet aperture 43 and enters the channels provided in the fan-shaped members 33, 35. The liquid is then expelled through the outlets 37, 39 and impinges on the inner surface of the mesh 19 to dislodge any particulates or other matter trapped in the outer surface thereof. The angular inclination of the outlets 37, 39 causes the member 25 to rotate so that the outlets traverse substantially all of the inside surface of the mesh 19.

A portion of the filtered water introduced into the pillar 27 is allowed to escape between the shaft portion 36 and the annular projections 29, 31 in order to clean the bearings on which the rotatable member 25 rotates. In practice, the rotatable member 25 may be supported by the water as it escapes under pressure and, in use, the rotatable member may effectively “float”. This arrangement helps to ensure that the rotatable member 25 is balanced. The intentional release of water to clean the bearing is facilitated by providing a gap of 1 mm between the shaft portion 36 and each of the annular projections 29, 31.

The particulates dislodged from the outer surface of the mesh 19 sink to the bottom of the central chamber 3. The hollow frusto-conical baffle plate 45 reduces the velocity of the liquid in the lower portion of the central chamber 3. The liquid's ability to transport particulates is thereby reduced and the particulates are caused to settle on the base of the chamber relatively quickly.

The filtered water is returned to the body of water via the system outlet 20. An outlet conduit (not shown) is connected to the system outlet 20 to deliver the filtered water to the desired location. The conduit may have a plurality of openings to discharge the filtered water in different locations.

When the filtration system 1 is operating in the purging mode, the liquid supply for the system 1 is fed directly to the inlet 16 of the pump 15, as shown in FIG. 10. The pump 15 pumps the supply liquid into the central chamber 3 on the outside (i.e. upstream) of the cylindrical mesh 19, to expel the particulates which have settled on the base of the chamber through the first discharge outlet 11, and also to expel particulates collected in the settling chamber 55 through the second discharge outlet 57. During the purging mode, the pressure in the central chamber 3 may be greater than atmospheric pressure to assist in the expulsion of the accumulated particulates.

The purging operation is preferably performed periodically for 10 to 15 seconds. The outlet from the annular chamber 5 housing the biological filter and/or the supply to the rotatable member 25 is/are preferably closed during the purging operation.

A flow compensating valve 75 is also provided between the change-over valve system 7 and the UV module 14. The operation of the flow compensating valve 75 in this embodiment is unchanged from the description outlined elsewhere herein.

The second embodiment described herein may also be provided with an inlet filter (not shown) for filtering particulates from the liquid to be supplied to the rotatable member 25.

A method of manufacturing filters for the first and second embodiments of the filtration system will now be described. In known systems, the support frame or housing for the filter was first produced, for example by moulding from plastics material, and the filter mesh subsequently secured in position using suitable mechanical fasteners.

In the first and second embodiments described herein, the mesh 19 and the frame members 21 may be moulded together to form a single integral unit.

The mesh 19 is formed first, for example from polyester, and is located in a mould cavity. To assist in handling, the mesh 19 may be moulded with or inserted into a support member which is also inserted into the mould cavity. Plastics material is then injected into the mould to form the frame and to fix the filter mesh and the support member, if used, in position.

The insert moulding of the filter mesh 19 ensures that it is fixedly secured in the frame members 21. Thus, this manufacturing process can help improve the resilience of the filter and increase its longevity.

The embodiments described herein are manually primed prior to use. However, the person skilled in the art will appreciate that the system may be self-priming. A self-priming system would initially draw air through the filtration system 1 which in turn would draw water through the system. A pump capable of drawing both air and water may be used to self-prime the system, but preferably a separate air pump is provided.

Although the change-over valve system 7 has been described as being manually operated, it will be appreciated that an automatic valve may be provided which responds, for example, to a programmable timer or a pressure switch.

The skilled person will also appreciate that a separate dedicated pump may be provided to supply liquid to the rotational member 25. The pump 15 may draw liquid directly from the filter chamber 23 or from the conduit connecting the central chamber 3 with the annular chamber 5. Indeed, a dedicated liquid supply from any source could be used.

Furthermore, rather than inclining the outlets 37, 39 of the fan-shaped members 33, 35 to effect rotation of the member 25, a separate mechanical drive may be provided. Indeed, the liquid may be introduced into the central chamber 3 tangentially to create a rotational movement which in turn may rotate one or more paddles which are drivingly connected to the rotatable member 25. The rotational motion of the liquid in the annular chamber 5 may equally be used to rotate paddles to drive the rotatable member 25.

It will also be appreciated that the pressure relief valve described herein could be modified to measure and/or react to the differential pressure across the mesh 19. This arrangement would facilitate improved mesh overload control. However, this arrangement would not afford the same level of protection for the sealed vessel against excessive pressure reduction if, for example, the pond inlet becomes blocked. A further relief valve may therefore be provided to limit the reduction of pressure in the sealed vessel which operated by introducing air into the vessel. Although the introduction of air into the system 1 would necessitate that it is re-primed, this is clearly preferable to damaging the sealed vessel or pump. Alternatively, the sealed vessel could be strengthened to ensure that the pump 15 could not reduce the pressure in the vessel sufficiently to cause it to collapse and only the differential across the mesh 19 would have to be controlled.

Although the system has been described herein with reference to filtering the water in a pond, it will be appreciated that it may be used to filter other liquids and may also be used to filter water for irrigation, fisheries, hatcheries, swimming pools and baths.

1. A filtration system comprising at least one flexible filter for filtering a fluid and cleaning apparatus for projecting a flow of fluid onto the at least one flexible filter; wherein, in use, the fluid to be filtered passes through the at least one flexible filter and causes the at least one flexible filter to be deflected in a first direction, and the flow of fluid projected onto the at least one flexible filter from the cleaning apparatus causes the at least one flexible filter to be deflected in a second direction.

2. A filtration system as claimed in claim 1, wherein the at least one filter defines a chamber.

3. A filtration system as claimed in claim 2, wherein said at least one filter is deflected inwardly, into said chamber, by the passage of the fluid to be filtered through the at least one filter and is deflected outwardly, out of said chamber, by the flow of fluid projected from the cleaning apparatus.

4. A filtration system as claimed in claim 1, wherein the cleaning apparatus comprises a rotatable member.

5. A filtration system as claimed in claim 1, wherein the at least one flexible filter is supported by a frame member.

6. A filtration system as claimed in claim 1, wherein the at least one flexible filter is bowed when it is deflected in said first and second directions.

7. A filtration system as claimed in claim 1, comprising a plurality of flexible filters, wherein the flexible filters are arranged to form a cylinder.

8. A filtration system as claimed in claim 1, wherein the at least one flexible filter is made of polyester.

9. A filtration system as claimed in claim 1, wherein the at least one filter is made of a plastics material having anti-bacterial properties.

10. A filtration system operable in a filtration mode and a purging mode, the system comprising at least one flexible filter; wherein, in use, said at least one flexible filter is deflected in a first direction when the system is operating in said filtration mode, and is deflected in a second direction when the system is operating in said purging mode.

11. A filtration system for filtering particulate material from a fluid, the filtration system comprising at least one flexible filter capable of being deflected by the flow of fluid through it.

12. A filter for filtering particulates from a flow of fluid, the filter comprising at least one flexible filter mesh capable of being deflected by the flow of fluid through it.

13. A filter as claimed in claim 12, wherein the filter is a cylindrical filter.

14. A method of manufacturing a filter for a filtration system, the filter comprising at least one filter mesh and a frame, the method comprising the steps of:
(a) locating said at least one filter mesh in a mould; and
(b) injecting plastics material into the mould to form said frame and to fix said at least one filter mesh in said frame.

15. A method as claimed in claim 14, wherein said at least one filter mesh is mounted in a support member and said support member and the filter mesh are located in the mould prior to the injection of said plastics material.

16. A method as claimed in claim 1, wherein said at least one filter mesh is flexible and, in use, is capable of being deflected by the flow of fluid through it.

17. A method as claimed in 1, wherein said filter is a cylindrical filter

18. A filter manufactured by the method claimed in claim 1.

19. A filtration system for filtering particulates from a liquid, the system comprising a sealed vessel suitable for supporting a pressure less than atmospheric pressure, and a filter for filtering particulates from said liquid.

20. A filtration system as claimed in claim 19, wherein a first chamber is defined in the sealed vessel and the filter is provided in said first chamber.

21. A filtration system as claimed in claim 19 comprising air evacuation means suitable for evacuating air from the system.

22. A filtration system as claimed in claim 21, wherein the air evacuation means is arranged to evacuate air from the sealed vessel.

23. A filtration system as claimed in claim 21, wherein the air evacuation means is a venturi.

24. A filtration system as claimed in claim 19 further comprising a pump suitable for reducing the pressure in said sealed vessel to cause liquid to be drawn into the vessel.

25. A filtration system as claimed in claim 23, wherein the venturi is connected on the pressure side of the pump.

26. A filtration system as claimed in claim 24 further comprising a valve sub-system operable to change the connection of the pump to the sealed vessel.

27. A filtration system as claimed in claim 26, wherein the valve sub-system is operable to connect the pump upstream of the sealed vessel to cause the system to operate in a purging mode.

28. A filtration system as claimed in claim 27, wherein, when the system is operating in said purging mode, the pump introduces a purging liquid into the sealed vessel to flush filtered particulates through a discharge outlet.

29. A filtration system as claimed in claim 28, wherein the valve sub-system is operable to open and/or close the discharge outlet.

30. A filtration system as claimed in claim 28, wherein the purging liquid is liquid taken from upstream of the filter.

31. A filtration system as claimed in claims 26, wherein the valve sub-system is operable to connect the pump downstream of the sealed vessel to cause the system to operate in a filtration mode.

32. A filtration system as claimed in claim 31, wherein, when the system is operating in the filtration mode, the pump draws the liquid supply into the system through a system inlet, the system inlet being connected to at least one conduit having at least one opening.

33. A filtration system as claimed in claim 19 further comprising a biological filter.

34. A filtration system as claimed in claim 33, wherein said biological filter is provided in a second chamber having an annular cross-section and extending circumferentially around the sealed vessel.

35. A filtration system as claimed in claim 34, wherein biological filter comprises media and the inlet to the second chamber is arranged such that, when liquid is drawn into the second chamber, the media are agitated.

36. A filtration system as claimed in claim 19 further comprising a UV light module.

37. A filtration system as claimed in claim 19 further comprising a filter cleaning apparatus for projecting a cleaning liquid onto a downstream side of the filter to dislodge particulates trapped on an upstream side thereof.

38. A filtration system as claimed in claim 37 further comprising a flow compensating device for increasing the proportion of the cleaning liquid directed to the filter cleaning apparatus when the filter is partially blocked.

39. A filtration system as claimed in claim 38, wherein the flow compensating device is a spring-loaded valve.

40. A filtration system as claimed in claim 37, wherein the cleaning liquid is liquid filtered by the filter.

41. A filtration system as claimed in claim 37, wherein the valve sub-system is operable to connect the pump downstream of the sealed vessel to cause the system to operate in a filtration mode and the cleaning liquid is supplied to the filter cleaning apparatus only when the system is operating in a filtration mode.

42. A filtration system as claimed in claim 41, wherein the supply of cleaning liquid is controlled by the valve-subsystem.

43. A filtration system as claimed in claim 37, wherein the valve sub-system is operable to connect the pump upstream of the sealed vessel to cause the system to operate in a purging mode; when the system is operating in said purging mode, the pump introduces a purging liquid into the sealed vessel to flush filtered particulates through a discharge outlet the purging liquid being introduced into the sealed vessel through said filter cleaning apparatus when the system operates in said purging mode.

44. A filtration system as claimed in claim 37 further comprising a pump suitable for reducing the pressure in said sealed vessel to cause liquid to be drawn into the vessel, wherein the cleaning liquid is supplied to the filter cleaning apparatus by the pump.

45. A filtration system as claimed in claim 37, wherein the cleaning liquid is supplied to the filter cleaning apparatus by a separate dedicated pump.

46. A filtration system as claimed in claim 37, wherein the cleaning apparatus comprises a rotatable member having an outlet for projecting the cleaning liquid onto a surface of the filter.

47. A filtration system as claimed in claim 45 wherein the rotatable member is rotatably mounted on a tubular member having at least one side-opening for supplying cleaning liquid to said rotatable member.

48. A filtration system as claimed in claim 47 further comprising a closure member for closing an end of the tubular member and for re-directing liquid introduced into the tubular member through the at least one side-opening.

49. A filtration system as claimed in claim 48, wherein the closure member is generally frusto-conical in shape.

50. A filtration system as claimed in claim 48, wherein the closure member is fixedly attached to the tubular member.

51. A filtration system as claimed in claim 48, wherein the closure member is integrally formed with the tubular member.

52. A filtration system as claimed in claim 19, wherein the filter is a cylindrical mesh defining a third chamber.

53. A filtration system as claimed in claim 52 wherein the filter is provided in said sealed vessel and the liquid supply is introduced into the sealed vessel to the outside of the cylindrical mesh.

54. A filtration system as claimed in claim 19, wherein the filter is provided in an upper portion of the sealed vessel to facilitate, in use, the settling of particulates in a lower portion thereof.

55. A filtration system as claimed in claim 54, wherein at least one baffle plate is provided in the sealed vessel.

56. A filtration system as claimed in claim 55, wherein the at least one baffle plate is hollow frusto-conical in shape.

57. A filtration system as claimed in claim 54, wherein a settling chamber is defined in a lower portion of the sealed vessel.

58. A filtration system as claimed in claim 57, wherein the settling chamber is provided beneath the filter.

59. A filtration system as claimed in claim 57, wherein the settling chamber is defined by a cylindrical member open at its upper end.

60. A filtration system as claimed in claim 57, wherein the settling chamber is provided with an outlet for evacuating particulates.

61. A filtration system as claimed in claim 19 further comprising a pressure relief valve.

62. A filtration system as claimed in claim 61 wherein the pressure relief valve is operable to prevent the pressure in the sealed vessel falling below a predetermined level.

63. A filtration system as claimed in claim 61 further comprising a pump suitable for reducing the pressure in said sealed vessel to cause liquid to be drawn into the vessel, wherein the pressure relief valve is operable to place an outlet of the pump in communication with an inlet of the pump when the pressure in the sealed vessel falls below said predetermined level.

64. A filtration system for filtering particulates from a fluid, the filtration system comprising a filter and a chamber for collecting particulates; the system further comprising at least one baffle member for reducing the velocity of fluid in the chamber and/or the velocity of fluid entering said chamber.

65. A filtration system as claimed in claim 64, wherein said at least one baffle member is ring-shaped in plan form.

66. A filtration system as claimed in claim 6 wherein said at least one baffle member is hollow frusto-conical in shape.

67. A filtration system as claimed in claim 64, wherein said at least one baffle member has a downwardly sloping top surface.

68. A filtration system as claimed in claim 64 comprising first and second baffle members, wherein the first baffle member has a first top surface and the second baffle member has a second top surface, the first top surface sloping downwardly in a first direction and the second top surface sloping downwardly in a second direction, said first and second directions being substantially opposite to each other.

69. A filtration system as claimed in claim 68, wherein the first and second baffle members are ring-shaped in plan form, the first direction being radially outwards and the second direction being radially inwards.

70. A filtration system as claimed in claim 69, wherein the first baffle member is provided above the second baffle member.

71. A container for collecting particulates in a fluid filtration system, the container having a chamber and being provided with at least one baffle member for reducing the velocity of fluid in the chamber and/or the velocity of fluid entering said chamber.

72. A container as claimed in claim 71, wherein the or each baffle plate is ring-shaped in plan form.

73. A container as claimed in claim 71, wherein the or each baffle member is hollow frusto-conical in shape.

74. A container as claimed in claim 71, wherein said at least one baffle member has a downwardly sloping top surface.

75. A method of operating a filtration system to filter particulates from a liquid, the method including a filtration step and a purging step;
the filtration step comprising reducing the pressure in a sealed vessel below atmospheric pressure to cause liquid to be drawn into the sealed vessel, and passing liquid to be filtered through a filter;
the purging step comprising introducing a purging liquid into the sealed vessel to expel particulates filtered from the liquid through a discharge outlet.

76. A method as claimed in claim 75, wherein a pump reduces the pressure in the sealed vessel by drawing liquid out of the sealed vessel; and the purging liquid is introduced into the sealed vessel by the same pump.

77. A method as claimed in claim 76, wherein a changeover valve is operated to change the pump connections to the sealed vessel to change the operational mode of the filtration system.

78. A method as claimed in claim 75, wherein the purging liquid is liquid taken from the same source as the liquid to be filtered.

79. A filter cleaning apparatus comprising a rotatably mounted member having at least one outlet for projecting cleaning liquid onto a surface of a filter, the rotatable member having a channel connecting at least one inlet aperture to said at least one outlet, the rotatable member being mounted on a tubular member having at least one side-opening therein, the at least one side-opening being in liquid communication with said at least one inlet aperture.

80. A filter cleaning apparatus as claimed in claim 79, wherein the rotatable member comprises a central collar, said collar extending substantially around said tubular member and being at least partially open to the interior thereof to define said at least one inlet aperture.

81. A filter cleaning apparatus as claimed in claim 79, wherein first and second annular projections are provided on the outer surface of the tubular member to axially locate said rotatable member.

82. A filter cleaning apparatus as claimed in claim 79, wherein a closure member is provided for directing liquid introduced into the tubular member radially outwardly into the at least one inlet aperture in the rotatable member.

83. A filter cleaning apparatus as claimed in claim 82, wherein the closure member is frusto-conical in shape.

84. A filter cleaning apparatus comprising a rotatable member having at least one outlet for projecting fluid onto a surface of a filter, the rotatable member comprising a collar rotatably mounted on a support member and there being provided at least one fluid pathway for allowing fluid to escape between the support member and the collar.

85. A filter cleaning apparatus as claimed in claim 84, wherein a first guide member is provided on the support member to limit upwards displacement of the rotatable member relative to the support member; wherein the fluid pathway or one of said fluid pathways is formed by a gap provided between the collar and said first guide member.

86. A filter cleaning apparatus as claimed in claim 85, wherein the gap between the collar and the first guide member is less than or equal to 1 mm.

87. A filter cleaning apparatus as claimed in claim 85, wherein the first guide member extends around the support member.

88. A filter cleaning apparatus as claimed in claim 84, wherein a second guide member is provided on the support member to limit downwards displacement of the rotatable member relative to the support member; wherein the fluid pathway or one of said fluid pathways is formed by a gap provided between the collar and said second guide member.

89. A filter cleaning apparatus as claimed in claim 88, wherein the gap between the collar and the second guide member is less than or equal to 1 mm.

90. A filter cleaning apparatus as claimed in claim 88, wherein the second guide member extends around the support member.

91. A filter cleaning apparatus as claimed in claim 84, wherein said at least one fluid pathway is annular and extends substantially around the support member.

92. A filter cleaning apparatus as claimed in claim 84, wherein the support member is a tubular member.

93. A filtration system comprising a chamber housing a biological filter media, wherein liquid to be biologically filtered is introduced into the chamber through an inlet, and said inlet is arranged such that, in use, the liquid agitates the filter media.

94. A filtration system as claimed in claim 93, wherein the inlet is arranged such that, in use, the liquid is introduced into the chamber in a tangential direction for creating a rotational flow in said chamber.

95. A filtration system as claimed in claim 93, wherein the chamber is annular in cross-section.

96. A filtration system as claimed in claim 95, wherein the annular chamber extends circumferentially around a central chamber.

97. A filtration system as claimed in claim 96, wherein said central chamber houses a mechanical filter.

98. A filtration system for filtering water from a body of water, the system comprising a filter and a pump, the filter being provided on the suction side of the pump when the system is operating in a filtration mode; wherein the system is adapted to allow water from the body of water to be filtered when the system is located above the water level in the body of water.

99. A sealed vessel to be used in the filtration system of any one of claim 1.

100. A vessel for use in a filtration system, the vessel comprising a collection chamber for collecting particulates filtered from a fluid, wherein a settling chamber is provided in said collection chamber.

101. A vessel as claimed in claim 100 further comprising a first discharge outlet to facilitate expulsion of filtered particulates from the collection chamber and a second discharge outlet to facilitate expulsion of filtered particulates from the settling chamber.

102. A vessel as claimed in claim 100 wherein the settling chamber is defined by a cylindrical sidewall and is open at its upper end.

103. A vessel as claimed in claim 100, further comprising a baffle plate.

104. A vessel as claimed in claim 103 wherein the baffle plate is hollow frusto-conical in shape.

105. A filtration system comprising a vessel as claimed in claim 100.

106. A filtration system as claimed in claim 105 further comprising a cylindrical filter.

107. A filtration system as claimed in claim 106 wherein the settling chamber is provided below the filter.

108. A filtration system as claimed in claim 107 wherein the settling chamber is cylindrical and the settling chamber and the filter are arranged co-axially.

109. A filtration system substantially as herein described with reference to FIGS. 1 to 8; or FIGS. 1 to 6, 9 and 10.

110. A vessel for use in a filtration system substantially as herein described with reference to FIGS. 1 to 8; or FIGS. 1 to 6, 9 and 10.

111. A filter cleaning apparatus substantially as herein described with reference to FIGS. 1 to 8; or FIGS. 1 to 6, 9 and 10.
